(19) United States
(12) Patent Application Publication
(10) Pub. No.: US 2018/0097753 A1
(43) Pub. Date: Apr. 5, 2018

(54) Reminder Completion Assistance in Group Conversation

(71) Applicant: Microsoft Technology Licensing, LLC, Redmond, WA (US)

(72) Inventors: Deepinder S. Gill, Hyderabad (IN); Karuna Koneru, Hyderabad (IN); Suryanarayana Shastri, Hyderabad (IN); Arun Kumar, Hyderabad (IN); Manikanth Immidi, Hyderabad (IN); Sibabrata Paladhi, Hyderabad (IN); Ananth Janakiram BV, Hyderabad (IN)

(21) Appl. No.: 15/355,371

(22) Filed: Nov. 18, 2016

(30) Foreign Application Priority Data
Sep. 30, 2016 (IN) 201641033607

(51) Int. Cl. H04L 12/58; H04L 29/08

(52) U.S. Cl. CPC H04L 51/046; H04L 67/18

(57) ABSTRACT

A process of providing reminder completion assistance in a group conversation. The process comprises: analyzing the content and context of a group conversation; identifying a potential implicit action; and suggesting a reminder based on the implicit action.

### RELATED APPLICATION

This application claims priority to Indian Application No. 201641033607 filed Sep. 30, 2016, which is incorporated herein by reference.

### BACKGROUND

Consumer preferences are quickly gravitating towards conversational platforms. These typically include messaging applications such as Skype, WhatsApp, and Messenger. Groups of users, with varying interests and preferences, are increasingly using these conversational platforms to do various tasks. One of the biggest missing pieces is assisting users in not missing tasks, appointments, or other important actions when they are on these conversational platforms.

### SUMMARY

Non-limiting examples of the present disclosure describe a process of providing reminder completion assistance in a group conversation. The process comprises: analyzing the content and context of a group conversation; identifying a potential implicit action; and suggesting a reminder based on the implicit action.

Further non-limiting examples of the present disclosure describe a system for providing reminder completion assistance in a group conversation. The system includes at least one processor; and a memory operatively connected with the at least one processor storing computer-executable instructions that, when executed by the at least one processor, causes the at least one processor to execute a method. The method comprises: extracting user preferences from a set of user signals; storing the extracted user preferences; analyzing the content and context of a group conversation; identifying a potential implicit action based on the analyzed content and context and the extracted user preferences; and suggesting a reminder based on the implicit action.

Further non-limiting examples of the present disclosure describe a non-transitory machine readable storage medium having stored thereon a computer program, the computer program comprising a routine of set instructions for causing the machine to perform the certain operations. Those operations include: extracting user preferences from a set of user signals; analyzing the content and context of a group conversation; identifying a potential implicit action based on the analyzed content and context and the extracted user preferences; and suggesting a reminder based on the implicit action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a block diagram illustrating an exemplary system for reminder completion assistance in group conversations in which aspects of the present disclosure may be practiced.

FIG. 2 is a flow chart of a method for extracting user preferences in which aspects of the present disclosure may be practiced.

FIG. 3 is a flow chart of a method for providing reminder completion assistance in group conversations in which aspects of the present disclosure may be practiced.

FIG. 4 is a block diagram illustrating example physical components of a computing device with which aspects of the disclosure may be practiced.

FIGS. 5A and 5B are simplified block diagrams of a mobile computing device with which aspects of the present disclosure may be practiced.

### DETAILED DESCRIPTION

Examples disclosed herein describe systems and methods for providing reminder completion assistance in group conversations. This disclosure makes setting reminders easy, through the use of a personal digital assistant, or “bot,” in a group conversation. A personal digital assistant can help users to do one or more of the following: a) explicitly setup a reminder about any tasks, events, or important data where a user wants to be reminded at an explicit time, location or when talking to the right people; b) explicitly recall a previously set reminders; c) remind a user about a particular task at a desired time, location or when talking to others; d) understand the semantics and context of the conversation when a user is in conversation with others and suggest to the user to set a reminder; and e) identify and understand important constructs around locations and contact lists (e.g. home, work, dad, mom, and wife). The disclosure helps users with the ability to create reminders and get notified about important events at the desired time, location, or when they are with particular people, through keeping the needs and preferences of users in mind, and enables users to send a reminder to others in a group chat which they can explicitly accept or deny.

This disclosure, when implemented in a computer environment, significantly makes computing more efficient by providing the user with prompts to set reminders, without having a user have to explicitly set the reminders on their own. In addition, by incorporating a personal digital assistant into a messaging application, the user interface may remain less cluttered for the user.

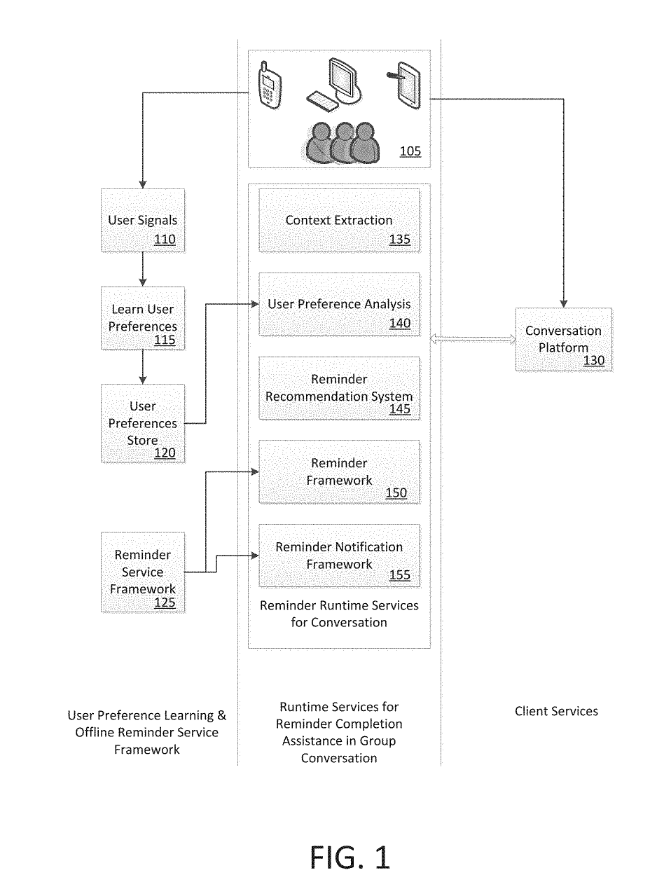

FIG. 1 is a block diagram illustrating an exemplary system for reminder completion assistance in group conversations in which aspects of the present disclosure may be practiced. The disclosure may be implemented in a combination of cloud based services and frameworks (blocks 110-125) and on a local computing device 105 (blocks 135-160). Those skilled in the art after reading this disclosure will appreciate that the location of the blocks, either on the cloud or on a local computing device, can be changed without changing the spirit of the present disclosure. For example, the User Preferences Store could be located on a local computing device 105 instead of in the cloud.

One or more local computing devices 105 may be used by one or more users. As users use the local computing device 105, certain user signals are extracted from the local computing device 105. These user signals may include, for example, the user's browsing history, the user's search history, the user's application usage, user information stored on local or cloud drives, the user's location, the user's contact list, who the user has been or is currently chatting with, and who the user has called or is currently calling. Using machine learning, data mining, or statistical reasoning, for example, the user's preferences are extracted (block 115) and stored in a User Preference Store 120. Examples of user preferences may be, for example, the user's home location, work location, family members, and contacts from her contact list. The reminder completion assistance application may use these stored user preferences to assist in determining potential reminders.

In addition to blocks 110-120, a Reminder Service Framework 125 may reside in the cloud. Reminder Service Framework 125 assists in the creation of reminders and updating reminders across various local computing devices 105 to notify users of contextual time, location, or people based reminders. A time based reminder would be a reminder to do a certain activity at a particular time, and would be triggered by the time occurring. A location based reminder would be a reminder to do a certain activity at a particular location and would be triggered by a local computing device being at that location. A people based reminder would remind a user of a particular activity when chatting with that particular person. Note that since the Reminder Service Framework is cloud based, a reminder initiated on one local computing device 105 would be pushed across each of a user's local computing devices 105.

A conversation platform 130 typically resides on a local computing device 105, but may also reside in a cloud. Messaging applications, such as Skype, WhatsApp, Messenger, Line, Blackberry Messenger, WeChat, and Hangouts, are examples of conversation platforms 130. Group conversations take place on the conversation platform 130, and the personal digital assistant, such as Cortana, will participate in group conversations as a “bot” in the conversation. As will be explained with respect to blocks 135-155, the personal digital assistant bot will monitor the conversation looking for either explicit or implicit reminder opportunities and will prompt users with potential reminders, and, upon confirmation, set such reminders. This is in contrast to prior art personal digital assistants that reside as separate interfaces outside of a conversation platform.

A Context Extraction Engine 135 monitors the group conversation and extracts the content and the context of the conversation based on the natural language content of the group conversation or “chat.” For example, the Context Extraction Engine 135 may identify the location of the chat or locations being referenced by the chat, the time of the chat or times referenced within the chat, and the people engaged in the chat. The User Preference Analysis Engine 140 draws information from the User Preference Store 120 about, for example, the various user's favorite locations (home and work, for example) and the users' contact lists. Based on a combination of the User Preference Analysis Engine data and the data extracted by the Context Extraction Engine 135, a Reminder Recommendation System 145 will identify what actions (data/resources/tasks/activities) are of interest to one or more users in the chat. Reminder Recommendation System 145 will search for implicit reminder recommendations to make and suggest users to add reminders for particular actions. It also permits for users to make explicit reminder requests. Reminder Framework 150 and Reminder Notification Framework 155 draw on information from the Reminder Service Framework 125 to deliver actual reminders to the users at particular times, locations, or chats with appropriate users. For example, certain reminders may be triggered when a user gets to work, in which case the Reminder Notification Framework 155 will provide a notification upon the user arriving at work.

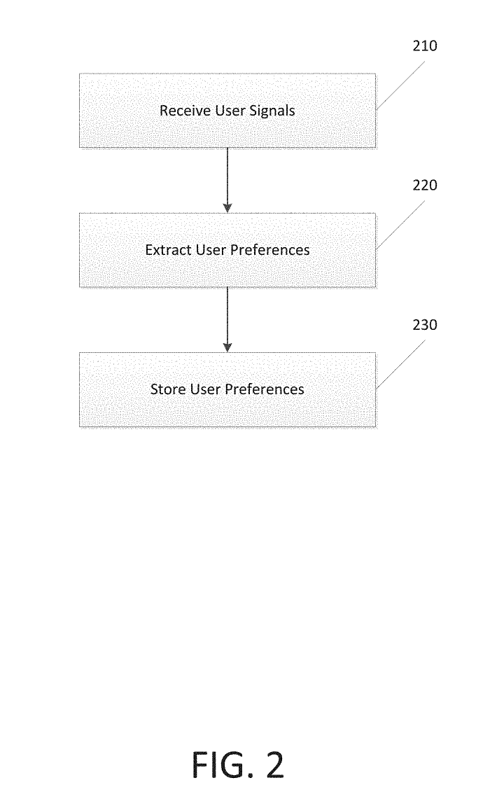

FIG. 2 is a flow chart of a method for extracting user preferences in which aspects of the present disclosure may be practiced. User signals are received by the method (stage 210). These user signals may include, for example, the user's browsing history, the user's search history, the user's application usage, user information stored on local or cloud drives, the user's location, the user's contact list, who the user has been or is currently chatting with, and who the user has called or is currently calling. Next, user preferences are extracted from the user signals (stage 220). Using machine learning, data mining, or statistical reasoning, for example, the user's preferences are extracted. Examples of user preferences may be, for example, the user's home location, work location, family members, and contacts from his contact list. The user preferences are then stored (stage 230). Please note that this process does not necessarily occur only once, but may be a continuous process that continues over a period of time as a user uses his computing device or devices.

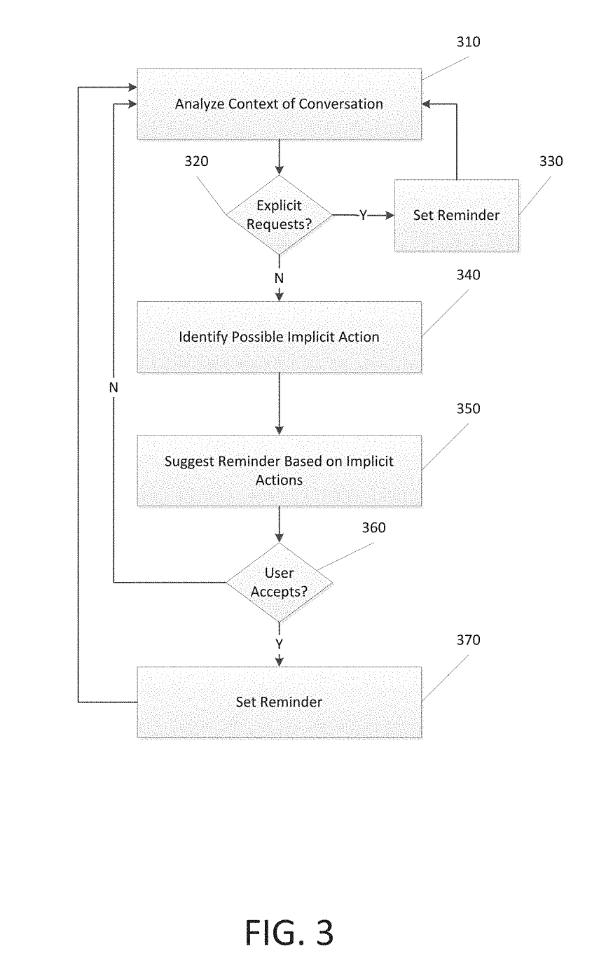

FIG. 3 is a flow chart of a method for providing reminder completion assistance in group conversations in which aspects of the present disclosure may be practiced. The content and context of a group conversation or chat is analyzed (stage 310). The chat is monitored and extracts the content and the context of the conversation based on the natural language content of the group conversation or “chat.” For example, identification may be made of the location of the chat or locations being referenced by the chat, the time of the chat or times referenced within the chat, and the people engaged in the chat. Explicit requests for reminders may be entered by a user (stage 320), and if so, a reminder is set (stage 330). Regardless of the presence of explicit requests, the method will identify possible implicit actions (stage 340). These are identified by using a combination of the extracted information from stage 310 and a user's preferences.

For example, the method knows the user's home location. During the course of a chat, a user may be having a conversation with a spouse and the spouse asks the user to mow the grass when he returns home. The method knows the user's home location from the user's preferences and identifies the activity that should be performed when she gets home. At this point, an implicit reminder may be identified to “mow the grass when I get home.” Similarly, during a chat, a first user may write that he will get a draft report to a second user this coming Tuesday. An implicit reminder may be identified for the first user for this coming Tuesday to “provide report to second user on Tuesday.”

Based on the implicit reminders identified, one or more implicit reminders may be suggested to the user (stage 350). If the user accepts (stage 360), a reminder will be set (stage 370). Regardless, the method constantly looks at the typed text to identify potential implicit reminders as flow continues to stage 310.

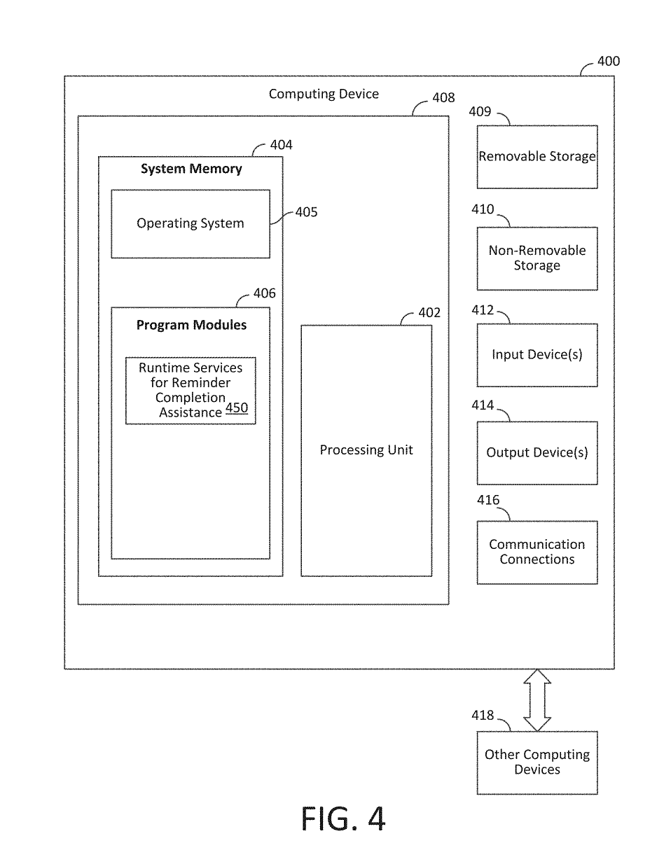

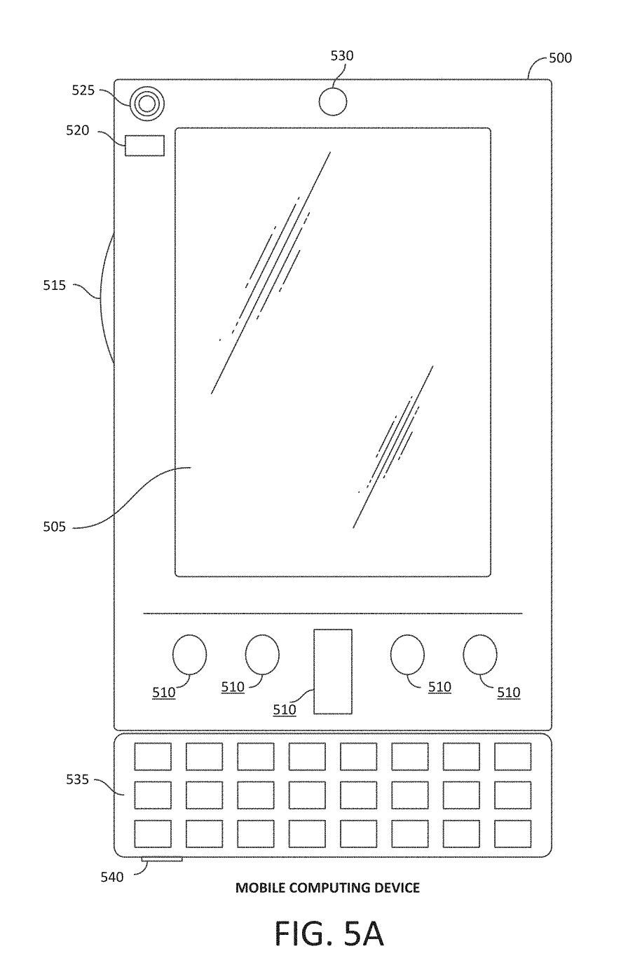

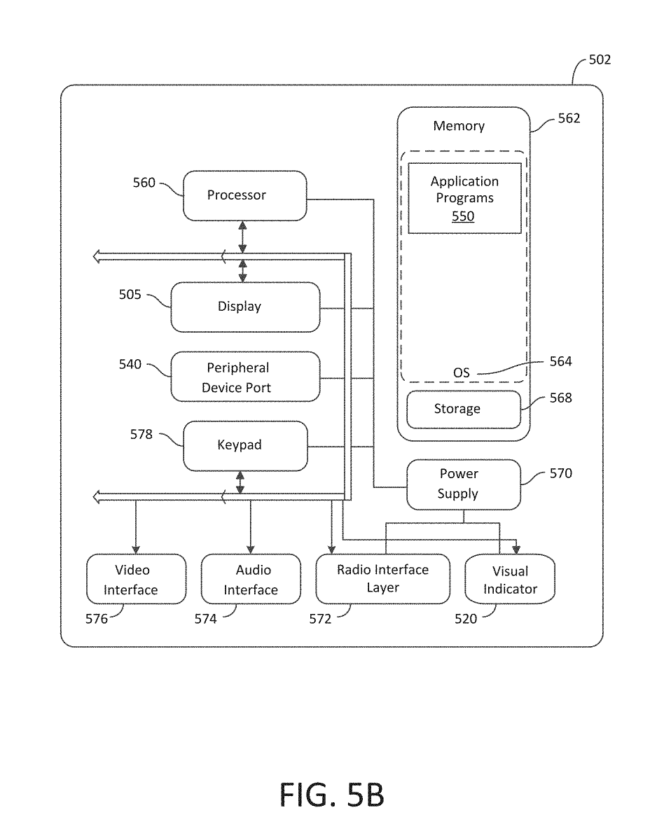

FIGS. 4-5 and the associated descriptions provide a discussion of a variety of operating environments in which aspects of the disclosure may be practiced. However, the devices and systems illustrated and discussed with respect to FIGS. 4-5 are for purposes of example and illustration and are not limiting of a vast number of computing device configurations that may be utilized for practicing aspects of the disclosure, as described herein.

FIG. 4 is a block diagram illustrating physical components (e.g., hardware) of a computing device 400 with which aspects of the disclosure may be practiced. The computing device components described below may have computer executable instructions for implementing a reminder completion assistance application 450 on a computing device, including computer executable instructions that can be executed to implement the methods disclosed herein. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running queue analysis application 450.

The operating system 405, for example, may be suitable for controlling the operation of the computing device 400. Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 (e.g., reminder completion assistance application 450) may perform processes including, but not limited to, the aspects, as described herein. Other program modules that may be used in accordance with aspects of the present disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 400 may also have one or more input device(s) 412 such as a keyboard, a mouse, a pen, a sound or voice input device, a touch or swipe input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 5A and 5B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative aspects, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device 500 can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, the reminder completion assistance application and so forth. The system 502 also includes a non-volatile storage area 868 within the memory 562. The non-volatile storage area 568 may be used to store persistent information that should not be lost if the system 502 is powered down. The application programs 566 may use and store information in the non-volatile storage area 568, such as email or other messages used by an email application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500, including the instructions for providing a queue analysis application.

The system 502 has a power supply 570, which may be implemented as one or more batteries. The power supply 570 may further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 866 via the operating system 564, and vice versa.

The visual indicator 520 may be used to provide visual notifications, and/or an audio interface 574 may be used for producing audible notifications via an audio transducer 525 (e.g., audio transducer 525 illustrated in FIG. 5A). In the illustrated embodiment, the visual indicator 520 is a light emitting diode (LED) and the audio transducer 525 may be a speaker. These devices may be directly coupled to the power supply 570 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone may also serve as an audio sensor to facilitate control of notifications, as will be described below. The system 502 may further include a video interface 576 that enables an operation of peripheral device 530 (e.g., on-board camera) to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data/information may be readily transferred between computing devices for storage and use according to well-known data/information transfer and storage means, including electronic mail and collaborative data/information sharing systems.

As should be appreciated, FIGS. 5A and 5B are described for purposes of illustrating the present methods and systems and are not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
analyzing the content and context of a group conversation;
identifying a potential implicit action; and
suggesting a reminder based on the implicit action.

2. The method of claim 1, further comprising, after analyzing the content and content of a group conversation, identifying an explicit request.

3. The method of claim 2, further comprising, if an explicit request has been made, setting a reminder based on the explicit request.

4. The method of claim 1, further comprising, after suggesting a reminder based on the implicit action, querying a user to determine if the user accepts the suggested reminder.

5. The method of claim 4, further comprising, if the user accepts the suggested reminder, setting a reminder.

6. The method of claim 1, wherein analyzing the content and context of a group conversation comprises:
processing the context of a group conversation based on one or more of the location of users in the group conversation, a location mentioned in the group conversation, a day of the group conversation, a day mentioned in the group conversation, a time of the group conversation, a time mentioned in the group conversation, and a user mentioned in the group conversation.

7. The method of claim 6, wherein identifying a potential implicit action comprises identifying an action based on the processed context of the group conversation.

8. The method of claim 6, wherein identifying a potential implicit action comprises identifying an action based on the processed context of the group conversation and a set of extracted user preferences.

9. A system comprising:
at least one processor; and
a memory operatively connected with the at least one processor storing computer-executable instructions that, when executed by the at least one processor, causes the at least one processor to execute a method that comprises:
extracting user preferences from a set of user signals;
storing the extracted user preferences;
analyzing the content and context of a group conversation;
identifying a potential implicit action based on the analyzed content and context and the extracted user preferences; and
suggesting a reminder based on the implicit action.

10. The system of claim 9, wherein the method, executed by the at least one processor, further comprises, after analyzing the content and content of a group conversation, identifying an explicit request.

11. The system of claim 10, wherein the method, executed by the at least one processor, further comprises, if an explicit request has been made, setting a reminder based on the explicit request.

12. The system of claim 9, wherein the method, executed by the at least one processor, further comprises, after suggesting a reminder based on the implicit action, querying a user to determine if the user accepts the suggested reminder.

13. The system of claim 12, wherein the method, executed by the at least one processor, further comprises, if the user accepts the suggested reminder, setting a reminder.

14. The system of claim 9, wherein analyzing the content and context of a group conversation comprises:
processing the context of a group conversation based on one or more of the location of users in the group conversation, a location mentioned in the group conversation, a day of the group conversation, a day mentioned in the group conversation, a time of the group conversation, a time mentioned in the group conversation, and a user mentioned in the group conversation.

15. The method of claim 14, wherein identifying a potential implicit action comprises identifying an action based on the processed context of the group conversation.

16. A non-transitory machine readable storage medium having stored thereon a computer program, the computer program comprising a routine of set instructions for causing the machine to perform the operations of:
extracting user preferences from a set of user signals;
analyzing the content and context of a group conversation;
identifying a potential implicit action based on the analyzed content and context and the extracted user preferences; and
suggesting a reminder based on the implicit action.

17. The non-transitory machine readable storage medium of claim 16 further comprising instructions for, after analyzing the content and content of a group conversation, identifying an explicit request.

18. The non-transitory machine readable storage medium of claim 17 further comprising instructions for, if an explicit request has been made, setting a reminder based on the explicit request.

19. The non-transitory machine readable storage medium of claim 16 further comprising instructions for, after suggesting a reminder based on the implicit action, querying a user to determine if the user accepts the suggested reminder.

20. The non-transitory machine readable storage medium of claim 19 further comprising instructions for, if the user accepts the suggested reminder, setting a reminder.
